(19) United States
(12) Patent Application Publication
(10) Pub. No.: US 2008/0273425 A1
(43) Pub. Date: Nov. 6, 2008

(54) Pendulum Clock

(75) Inventor: Peter Willem Marie TIELEN, America (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: TIELEN DESIGN, America (NL)

(21) Appl. No.: 12/111,263

(22) Filed: Apr. 29, 2008

(30) Foreign Application Priority Data
May 2, 2007 (GB) 0708489.0

(51) Int. Cl. G04B 17/02; G04B 29/00

(52) U.S. Cl. 368/179

(57) ABSTRACT

A pendulum clock comprising a pendulum clockwork with acoustic signaling means contained in a housing wherein the housing comprises vertical surface elements made of metal, optionally comprising openings in a minor part of the surface thereof, and wherein the housing comprises at least one horizontal surface element wherein the ratio of the specific surface mass of one horizontal and of the vertical metal surface elements is at least 3.

### RELATED APPLICATIONS

This application claims priority from Great Britain application number 0708489 filed on May 2, 2007 which is hereby incorporated by reference.

### BACKGROUND OF THE INVENTION

The invention relates to a pendulum clock comprising a pendulum clockwork with acoustic signaling means contained in a housing.

Pendulum clocks are well known and appreciated not only for their beautiful appearance as a piece of the furniture in the house, for the beauty of the technical detail of the clockwork and of course for the indication of the time using acoustic signals. As a pendulum clock is an entirely mechanical instrument, the acoustic signaling means typically are also mechanic acoustic means, for example metal bells, rods, chimes or gongs. An essential element of quality of a pendulum clock is the quality of the sound of the acoustic signaling means.

Nowadays, pendulum clocks are often considered old-fashioned. The classical pendulum clocks do not fit in well in modern architecture and in modern interior design. The inventor has taken on the challenge to revive the interest in pendulum clocks and produce pendulum clocks having a modern look.

### SUMMARY OF THE INVENTION

The new design pendulum clocks have a housing comprising vertical surface elements made of metal, for example chromium-nickel steel, optionally comprising openings in a minor part of the surface thereof. The metal housing provides a very modern glossy look that is more attractive in modern interiors. However, given the fact that the pendulum requires a minimum vertical size of the housing of typically at least 0.5 m, but preferably even more than 1 m, the problem arose that the acoustic properties of said housing are rather poor and/or the weight of the pendulum clock would be unacceptably high. On one hand, the vertical surface elements could not be made too thick because otherwise the clock would be too heavy. On the other hand, thinner vertical surface elements were found to produce an awful tinny metallic sound. Therefore, the object of the invention was to provide a pendulum clock comprises a housing comprising vertical surface elements made of metal having good acoustic properties and an acceptable weight.

This problem has been solved according to the invention in that the housing comprises at least one horizontal surface element, preferably the bottom surface element, wherein the ratio of the specific surface mass (SSM in kg per m² surface area) of one horizontal and of the vertical surface elements is at least 3, preferably at least 5 and even more preferably at least 7.

It was surprisingly found, that the acoustic properties of the housing increased significantly by significantly increasing the specific surface mass of one horizontal surface element relative to the vertical surface elements. Instead of an awful tinny metallic sound a warm resounding sound was produced.

### BRIEF DESCRIPTION OF THE DRAWINGS

The features and advantages of the invention will be appreciated upon reference to the following drawings, in which:

FIG. 1 is a front plan view of a pendulum clock according to one embodiment of the invention.

FIG. 2 is a side view of a pendulum clock according to one embodiment of the invention.

### DESCRIPTION OF ILLUSTRATIVE EMBODIMENT

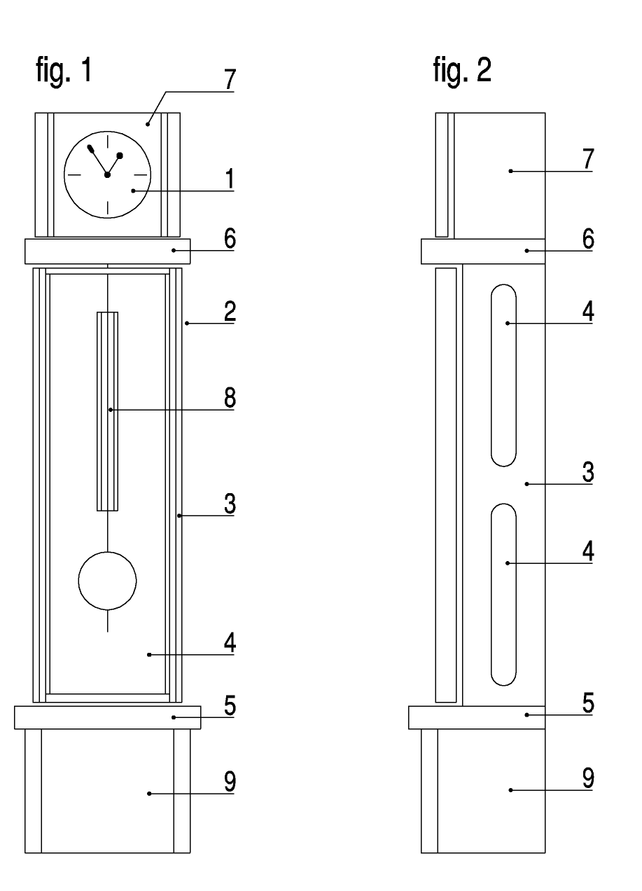

The following is a description of an embodiment of the invention, given by way of example only and with reference to the drawings. Referring to FIG. 1, a pendulum clock is shown according to a preferred embodiment of the invention showing housing (2) comprising a horizontal surface element (5) at the bottom, an upper surface element (6) and vertical surface elements (3). The upper horizontal surface element (6) divides the housing in an acoustic housing part (4), contained between the bottom and upper horizontal surface element (5) and (6), and a separate clockwork housing part (7) for the clockwork (1). The bottom surface element (5) and preferably also the upper horizontal surface element (6) have a high specific surface mass relative to the vertical surface elements (3), characterized in a SSM ratio of at least 3. The upper surface element (6) is provided with openings (not shown) to allow the pendulum (8) and optional acoustic signaling means (not shown) to protrude into the acoustic housing part and in case sound is produced in the clockwork (1) in separate housing (7) to resound in the acoustic housing part (4). The pendulum clock may be pending or standing on a foot (9), which may be integrated in the clock housing or entirely separate. FIG. 1 shows the front vertical surface (3) open to show the pendulum. The front vertical surface of the housing preferably has a large part covered with glass to show the pendulum.

FIG. 2 shows the same clock as shown in FIG. 1 in side view, showing openings (4), preferably also covered in glass.

### DETAILED DESCRIPTION OF THE INVENTION

The pendulum clock housing comprises an upper and a lower horizontal element. In one embodiment of the pendulum clock, the housing comprises one horizontal surface element in the bottom of the housing, preferably in the form of a flat plate. Said surface element has a specific surface mass ratio (relative to the vertical surface elements) of at least 3, preferably at least 5, and more preferably at least 7 (hereafter also referred to as the “heavy” plate). The specific surface mass is defined to be that of the plate material forming the housing in flat state, i.e. not including openings, glass inserts, corrugations or prophiles.

The horizontal surface element preferably is a metal plate, but can also be a stone or glass plate. The stone plate can be concrete, but preferably is natural stone, preferably marble or granite. Natural stone is preferred because it has a higher density. Considering the density differences between a horizontal natural stone plate (density about 2.7 kg/ltr) and the vertical metal housing elements (density of about 7.5 kg/ltr) the thickness of the horizontal surface element is at preferably at least 8, preferably 9 and more preferably at least 10 times the thickness of the vertical metal surface elements.

In a typical size pendulum clock according to the invention, wherein the housing is at least 0.5 m, preferably at least 0.7 m and even more preferably at least 1 m in vertical direction, the vertical metal surface elements have a thickness of between 0.5 and 3 mm, preferably between 1 and 2 mm and the horizontal surface elements have a thickness of at least 1.5-18 mm, preferably 4-12 mm in case of metal and 15-60 mm, preferably 20-50 mm in case of marble, natural stone or glass. Preferably the horizontal housing elements have a mass of at least 3 kg, preferably at least 4 kg, more preferably at least 5 kg.

The upper horizontal surface element is not necessarily a flat surface and may be shaped to accommodate the clockwork and to provide a decorative function to the clock housing. In view of the acoustic properties, it is preferred that the housing also comprises an upper horizontal surface that has a specific surface mass ratio of at least 3, preferably at least 5 and more preferably at least 7. The clockwork may be contained entirely within the housing. Alternatively, as described above in relation to FIGS. 1 and 2, the clockwork may be in a separate clockwork housing mounted on the upper horizontal surface of the pendulum housing, in which case the upper horizontal surface is provided with openings for the pendulum or optional other clock elements or acoustic elements and to provide passage for the sound to resound in the acoustic housing part.

The vertical metal surface elements are preferably formed from a ferro metal, preferably chromium-nickel steel, optionally combined with a non-ferro metal. For decorative reasons it is preferred to use mat metal elements optionally combined at least in part with glossy metal surfaces.

The vertical surface elements of the housing may comprise openings in the front and/or side surfaces, preferably covered at least in part with glass, preferably with a thickness between 4-8 mm. The openings have a decorative function but can also be used to tune the acoustic properties of the housing. The front surface of the pendulum clock housing preferably has one or more openings, preferably covered with glass to show the pendulum. The front surface may also be entirely of glass. It is preferred that at least the back and side vertical surfaces are made of metal optionally comprising openings only in a minor part of the surface thereof. This implies that the basic structural integrity of the housing is coming mainly from the metal surface elements of the side and back metal surfaces. The vertical and horizontal surface elements are connected by welding, screwing or gluing extensions provided on the horizontal or (more preferably) the vertical surface elements. To provide rigidity and strength to the housing, the vertical surface elements are preferably shaped by cold forming to make at least one fold along the vertical direction.

What is claimed is:

1. A pendulum clock comprising a pendulum clockwork with acoustic signaling means contained in a housing wherein the housing comprises vertical surface elements comprised of metal, and at least one horizontal surface element wherein the ratio of the specific surface mass (in kg per m² surface area) of one horizontal and of the vertical surface elements is at least 3.

2. The pendulum clock according to claim 1, wherein the horizontal surface element is a flat plate in the bottom of the housing.

3. The pendulum clock according to claim 1, wherein the specific surface mass ratio is at least 5.

4. The pendulum clock according to claim 1, wherein the vertical metal surface elements of the housing comprise a ferrous metal.

5. The pendulum clock according to claim 4, wherein the vertical metal surface elements of the housing comprise chromium-nickel steel.

6. The pendulum clock according to claim 4, wherein the vertical metal surface elements of the housing comprise a ferrous metal combined with a non-ferrous metal.

7. The pendulum clock according to claim 1, wherein the vertical metal surface elements have a thickness between 0.5 and 2 mm and the horizontal surface element has a thickness of at least 1.5-8 mm if comprised of metal and at least 20-50 mm if comprised of marble, natural stone or glass.

8. The pendulum clock according to claim 1, wherein the at least one horizontal surface element comprises a flat metal plate.

9. The pendulum clock according to claim 1, wherein the at least one horizontal surface element comprises a flat stone plate.

10. The pendulum clock according to claim 1, wherein the vertical metal surface elements are shaped by cold forming to have at least one fold along the vertical direction.

11. The pendulum clock according to claim 1, wherein the horizontal housing surface element has a mass of at least 4 kg.

12. The pendulum clock according to claim 1, wherein the housing also has an upper horizontal surface element having a specific surface mass ratio of at least 3.

13. The pendulum clock according to claim 1, wherein the housing has a flat upper horizontal surface element dividing the housing into a separate clockwork housing part containing the clockwork and an acoustic housing part, wherein the upper horizontal surface element is provided with one or more openings for the pendulum to extend into the acoustic housing part.

14. The pendulum clock according to claim 13, wherein the flat upper horizontal surface element dividing the housing has a specific surface mass of at least 3.

15. The pendulum clock according to claim 1, wherein housing comprises openings in a minor part of the surface thereof.
